(19) United States
(12) Patent Application Publication
(10) Pub. No.: US 2026/0029001 A1
(43) Pub. Date: Jan. 29, 2026

(54) Valve Assembly for Double-Acting Hoisting Mechanism

(71) Applicant: Robert Bosch GmbH, Stuttgart (DE)

(72) Inventors: Markus Bissbort, Contwig (DE); Steffen Knapper, Vaihingen/Enz (DE); Martin Schramm, Vaihingen/Enz (DE); Frank Rieckhof, Nienburg (DE); Markus Grammer, Ludwigsburg (DE)

(21) Appl. No.: 19/275,312

(22) Filed: Jul. 21, 2025

(30) Foreign Application Priority Data
Jul. 23, 2024 (DE) 10 2024 206 922.1

(51) Int. Cl. F15B 13/04

(52) U.S. Cl. CPC F15B 13/0405; F15B 2013/041; F15B 2211/3053; F15B 2211/50518; F15B 2211/526

(57) ABSTRACT

A valve assembly having a supply fluid flow path which passes from a first supply point via a pressure reducing valve, further via a first control point, and further via a 2/2-way poppet valve to a discharge point. The pressure reducing valve is adjustable using a first actuating solenoid. The first control point is connected on the inlet side to a shuttle valve. A first 3/2-way switching valve is arranged in the supply fluid flow path between the pressure reducing valve and the first control point, and is configured such that the first control point is selectively connected to the pressure reducing valve or to the first return flow point. The first 3/2-way switching valve is adjustable at least indirectly using a second actuating solenoid. A second control point is arranged between the pressure reducing valve and the first 3/2-way switching valve in the supply fluid flow path.

This application claims priority under 35 U.S.C. § 119 to patent application no. DE 10 2024 206 922.1, filed on Jul. 23, 2024 in Germany, the disclosure of which is incorporated herein by reference in its entirety.

The disclosure relates to a valve assembly as disclosed herein.

### BACKGROUND

The data sheet “Load-sensing directional control valves in disc design SB24-EHS4, SB34-EHS4” from Bosch Rexroth AG (order number RD 66174; edition 22.05.2023) discloses a modular system for a hydraulic valve block, wherein the valve block is composed of several separate valve discs. Such a valve block is used, for example, in an agricultural tractor or in another mobile machine. A valve disc can be used, for example, to control a cylinder of a hoisting mechanism of the aforementioned mobile machine. The valve block comprises a load detection system, wherein a shuttle valve of a shuttle valve cascade is arranged in each valve disc. The feed pressure of a pump, which supplies the valve block with pressure fluid via a first supply point, is regulated, for example, by the outlet pressure of the shuttle valve cascade, which corresponds to the highest load pressure of all valve discs.

EP 3 321 515 A1 discloses a valve assembly for controlling a hoisting mechanism. The cylinder for raising and lowering the hoisting mechanism is designed as a double-acting cylinder. A supply fluid flow path leads from a pressure fluid source via a pressure reducing valve, further via a first control point, further via a 2/2-way poppet valve to a cylinder clamp of the aforementioned cylinder. The pressure reducing valve is electrically adjustable by means of a first actuating solenoid, so that the corresponding hydraulic force acting on the cylinder can be adjusted. The other cylinder chamber is supplied by a further circuit arrangement, wherein the two circuit arrangements are independently adjustable. The corresponding adjustment is made during operation so that the desired behavior of the hoisting mechanism is achieved. The first control point is connected to an input of a shuttle valve of the shuttle valve cascade explained above. The 2/2-way poppet valve enables load holding, i.e. the load acting on the relevant cylinder can be supported solely via the 2/2-way poppet valve, wherein the cylinder does not move. The pump does not have to provide sufficient pressure to support the load. Load holding is switched electrically with a second actuating solenoid, independently of the setting of the pressure reducing valve. This allows pressure fluid to flow back from the relevant cylinder chamber to the tank via the pressure reducing valve if this is necessary to move the hoisting mechanism. During this movement of the hoisting mechanism, the load signal from the first control point to the shuttle valve cascade remains active, even though no volume flow from the pump is required. This can result in unnecessary energy losses.

### SUMMARY

The task of the disclosure is to provide a valve assembly comparable to EP 3 321 515 A1 for controlling one side of a double-acting cylinder, with which the energy losses explained above are avoided. The valve assembly according to the disclosure should also be operable with only two actuating solenoids. The valve assembly according to the disclosure should be realizable as a valve disc in the modular system explained at the beginning. The valve assembly according to the disclosure should be economically producible in small quantities, wherein variants for small and large volume flows should nevertheless be realizable. The valve disc should not increase the main dimensions of the known valve block according to the data sheet mentioned at the beginning. It should be noted here that, depending on the main dimensions mentioned, space is kept free in mobile machines for the installation of the valve block. The valve disc according to the disclosure should be particularly suitable for installation in existing mobile machines which are designed in accordance with the main dimensions of the valve block described above. The valve disc according to the disclosure should also be designed so that it can serve as an attachment point for securing the corresponding valve block to the mobile machine.

As disclosed herein, it is proposed that a first 3/2-way switching valve is arranged in the supply fluid flow path between the pressure reducing valve and the first control point, via which the first control point can be connected either to the pressure reducing valve or to the first return flow point, wherein the first 3/2-way switching valve is adjustable at least indirectly by means of the second actuating solenoid, wherein a second control point is arranged between the pressure reducing valve and the first 3/2-way switching valve in the supply fluid flow path, wherein the 2/2-way poppet valve can be actuated hydraulically via a first actuating connection, wherein the first actuating connection is connected to the second control point in such a way that the 2/2-way poppet valve can be adjusted indirectly by the first and/or the second actuating solenoid.

The 2/2-way poppet valve preferably has an open position in which the valve seat can be flowed through in both directions, wherein it has a closed position in which the valve seat is closed, most preferably in the manner of a non-return valve which allows fluid flow exclusively toward the outlet connection. A first spring preferably biases the 2/2-way poppet valve into the closed position, wherein the pressure at the first actuating connection acts on the 2/2-way poppet valve in the direction of the open position. The valve assembly is preferably designed in the form of a separate valve disc to form a valve block. It can also be part of a monolithic valve block.

If the connection between the first and second control points is blocked by the 3/2-way switching valve, the pressure at the second control point does not reach the shuttle valve. It should be noted that the pressure at the second control point, i.e. the outlet pressure of the pressure reducing valve, cannot usually drop completely to the pressure at the first return flow point. The 3/2-way valve therefore prevents an unnecessarily high pressure from being signaled to the shuttle valve cascade, which in turn prevents an unnecessarily high feed pressure of the pump.

Three operating modes can be implemented with the valve assembly according to the disclosure. In a first operating mode, leak-free load holding takes place, wherein in particular the 2/2-way poppet valve is closed.

In a second operating mode, active double-acting lift control takes place. The 2/2-way poppet valve is then open, wherein the first 3/2-way switching valve is in the first switching position, so that the pressure reducing valve determines the pressure on one of the two cylinder sides, wherein a further valve disc determines the pressure on the other cylinder side. In the second operating mode, electronic pressure control can take place by using the measured value of the pressure sensor at the sensor connection as the actual value of the corresponding control circuit, wherein the setting of the pressure reducing valve is used as the control variable of the said control circuit.

In a third operating mode, single-acting hoisting mechanism control takes place or the hoisting mechanism is in a floating position. The 2/2-way poppet valve is then open, wherein the 3/2-way switching valve is in the second switching position. The corresponding cylinder side is therefore connected to the tank. The other cylinder side can be pressurized or connected to the tank via another valve disc.

Additional advantageous developments and improvements are described herein.

It may be provided that only an inductor or only an inductor non-return valve is connected between the second control point and the first actuating connection. The inductor non-return valve is preferably installed such that the inductor in question is effective when flow passes from the second control point to the first actuating connection, wherein the inductor is bypassed by the open non-return valve when flow passes in the opposite direction. The inductors mentioned have preferably a fixed flow resistance. It is conceivable that the first actuating connection is permanently connected to the second control point with low resistance. Depending on the application, the design variant that works most reliably is preferably selected. An advantage of the valve assembly according to the disclosure is that the aforementioned design variants can be implemented by replacing a screw insert, so that the most suitable design variant can be selected during practical testing.

The disclosure may provide that the first 3/2-way switching valve can be moved into a first switching position by energizing the second actuating solenoid, in which the supply fluid flow path is open, wherein it is pretensioned by a second spring into a second switching position in which the first control point is connected to the first return flow point. If the power supply fails, the supply fluid flow path is thus blocked so that the hoisting mechanism no longer moves.

The disclosure may provide that a second 3/2-way switching valve is provided, which can be directly adjusted by means of the second actuating solenoid, wherein the first 3/2-way switching valve can be hydraulically actuated via a second actuating connection, wherein the second actuating connection is connected on the output side to the second 3/2-way switching valve. It is conceivable that the second actuating solenoid directly actuates the first 3/2-way switching valve. This variant is preferred for small fluid flows in the supply fluid flow path. The second 3/2-way switching valve is preferably used when high fluid flows flow in the supply fluid flow path. On the inlet side, the second 3/2-way switching valve is preferably permanently connected to a second supply point and a second return flow point of the valve assembly.

The disclosure may provide that the valve assembly comprises a main body which has a first and a second sealing surface which are each formed flat and perpendicular to a longitudinal axis while facing away from each other, wherein the first supply point and the first return flow point are each formed as a channel parallel to the longitudinal axis directly in the main body, wherein said channel opens out at the first and second sealing surface, wherein a vertical axis is aligned perpendicular to the longitudinal axis, wherein the discharge point opens out in the direction of the vertical axis directly at a connection side on the main body, wherein a transverse axis is arranged perpendicular to the longitudinal axis and to the vertical axis. The valve assembly can thus be used in the manner of a valve disc in the valve block in accordance with the data sheet mentioned at the beginning. The main body is preferably designed in one piece. The second supply point and the second return flow point are preferably each formed as a channel parallel to the longitudinal axis directly in the main body, wherein the said channel opens out at the first and second sealing surfaces.

The disclosure may provide that the 2/2-way poppet valve and the pressure reducing valve are each designed as a cartridge valve, which is aligned parallel to the transverse axis, wherein the 2/2-way poppet valve and the pressure reducing valve are installed in the main body from a common valve side. The second 3/2-way switching valve is preferably also designed as a cartridge valve, which is aligned parallel to the transverse axis, wherein it is installed in the main body from the valve side. When the valve assembly according to the disclosure is installed in the valve block described at the beginning, the valve side is preferably the side on which at least one electrically actuable pilot valve is arranged on at least one other valve disc. This allows all necessary electrical lines to be routed to the valve block on the valve side. The cartridge valve is preferably designed as a screw-in valve.

The disclosure may provide that a front side main connection of the 2/2-way poppet valve is permanently connected to the discharge point in order to form a section of the supply fluid flow path, wherein the 2/2-way poppet valve is arranged adjacent to the connection side on the main body. The aforementioned section of the supply fluid flow path can thus be designed to be very short and therefore low-resistance. The 2/2-way poppet valve preferably has a radial main connection, wherein the corresponding valve seat is connected between the radial and the front side main connection.

The disclosure may provide that the first 3/2-way switching valve is designed as a cartridge valve which is installed parallel to the vertical axis in the main body, wherein the pressure reducing valve has a front side outlet connection which is permanently connected to a first radial connection of the first 3/2-way switching valve to form a portion of the supply fluid flow path. The said section of the supply fluid flow path can thus be designed to be very short and therefore low-resistance. The first 3/2-way switching valve is preferably installed in the main body from the connection side. The said cartridge valve is preferably designed as a screw-in valve.

The disclosure may provide that a radial main connection of the 2/2-way poppet valve is permanently connected to a second radial connection of the first 3/2-way switching valve to form a section of the supply fluid flow path. The said section of the supply fluid flow path can thus be designed to be very short and therefore low-resistance.

The disclosure may provide that the second actuating connection is arranged on the front side of the first 3/2-way switching valve. The first 3/2-way switching valve can thus be designed to be particularly compact, even if it is designed for high volume flows.

A pressure relief valve may be provided, via which the discharge point can be connected to the first return flow point. The pressure relief valve prevents hydraulic overload of the valve assembly, in particular of the discharge point mentioned above. The pressure relief valve can be equipped with a re-suction function so that pressure fluid flows from the return flow point to the discharge point when the pressure at the discharge point drops below the pressure at the return flow point.

The disclosure may provide that the pressure relief valve is designed as a cartridge valve which is aligned parallel to the vertical axis, wherein it is installed in the main body from the connection side. The pressure relief valve preferably has an emergency drain function with which it can be opened manually. With the proposed arrangement of the pressure relief valve, the emergency drain function can be easily operated by the user of the valve assembly because it is easily accessible in the mobile machine. The cartridge valve is preferably designed as a screw-in valve.

The disclosure may provide that at least one fastening thread is arranged in the main body on the side facing away from the connection side in the direction of the vertical axis, which passes parallel to the vertical axis. The valve block with the valve assembly can be securely fastened to the mobile machine via this fastening thread. It should be noted that the valve assembly according to the disclosure has a higher weight than the other valve discs of the valve block, so that the attachment options usually provided on the valve block alone are no longer sufficient to attach the valve block securely to the mobile machine. Preferably, several fastening threads are provided, which are arranged offset with respect to one another in the direction of the longitudinal axis with a constant pitch, wherein the pitch corresponds to a thickness of one of the remaining valve discs of the valve block. Said thickness is preferably the same for almost all valve discs of the valve block, wherein the valve disc according to the disclosure is thicker in comparison.

The disclosure may provide that a control fluid flow path passes from the shuttle valve via a first inductor, further via the first control point, further via a second inductor either to the second or to the first return flow point. The first inductor prevents strong pressure fluctuations at the first control point from being reported to the shuttle valve cascade. The second inductor creates a permanent leak to the tank so that a small volume flow always flows through the pressure reducing valve and/or the pressure relief valve during control operation, thus preventing oscillations of the pressure reducing valve or the pressure limiting valve. The first and/or the second inductor preferably has a fixed flow resistance.

Of course, the above-mentioned features and those to be explained below can be used not only in the combination indicated in each case, but also in other combinations or on their own, without going beyond the scope of the disclosure.

### BRIEF DESCRIPTION OF THE DRAWINGS

The disclosure is explained in more detail below with reference to the enclosed drawings. The figure shows:

FIG. 1 a hydraulic circuit diagram of a first embodiment of a valve assembly according to the disclosure;

FIG. 2 a hydraulic circuit diagram of a second embodiment of a valve assembly according to the disclosure;

FIG. 3 a perspective view of the valve assembly according to FIG. 2 from the valve side; and

FIG. 4 a further perspective view of the valve assembly according to FIG. 3 from the opposite side.

### DETAILED DESCRIPTION

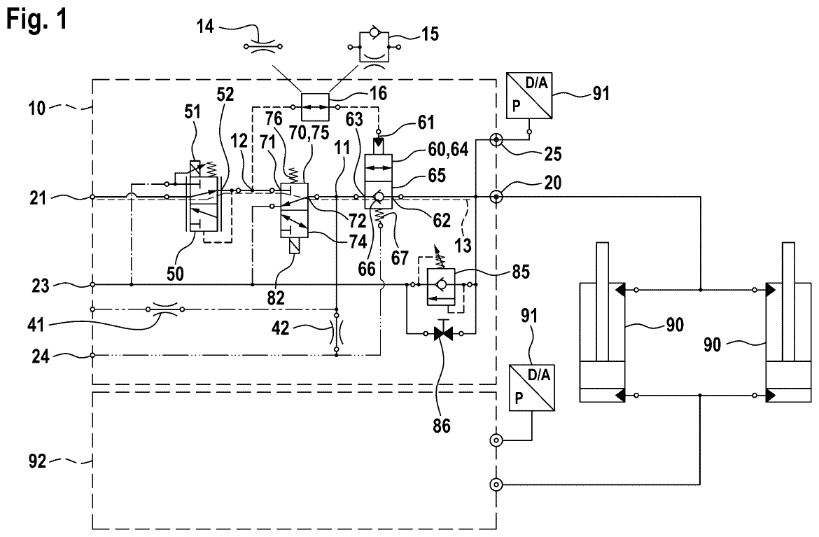

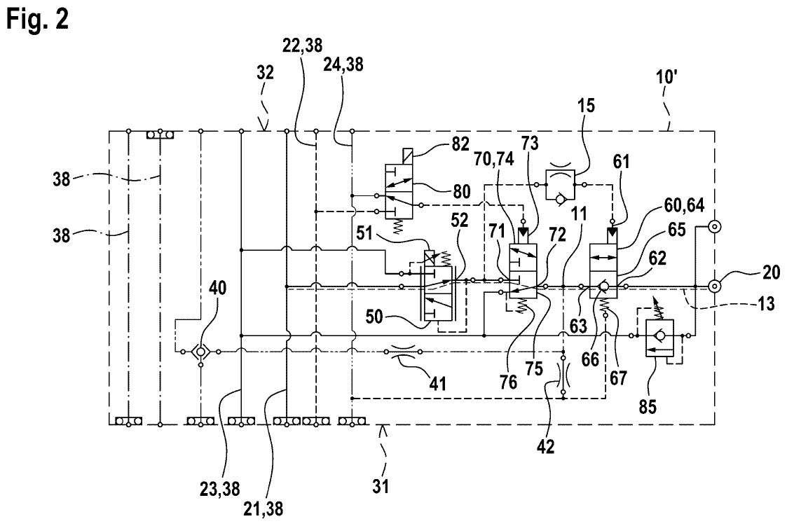

FIG. 1 shows a hydraulic circuit diagram of a first embodiment of a valve assembly 10 according to the disclosure. The first embodiment is intended for low volume flows in the supply fluid flow path 13, which is why the first 3/2-way switching valve 70 is actuated directly with the second actuating solenoid 82. In the second embodiment shown in FIG. 2, on the other hand, indirect actuation is provided by means of the second 3/2-way switching valve (no. 80 in FIG. 2). In all other respects, the first and second embodiments are identical, so that all the explanations relating to FIG. 1 also apply to FIG. 2. Conversely, in the first embodiment, the channels parallel to the longitudinal axis (no. 38 in FIG. 2) and the shuttle valve there (no. 40 in FIG. 2) are also present, which have been omitted in FIG. 1 for the sake of clarity.

The valve assembly 10 the hydraulic cylinders 90 of a hoisting mechanism of a mobile working machine. In the present case, two such cylinders 90 are provided, which are connected in parallel. The lowering side of the cylinders 90 is connected to the discharge point 20 of the valve assembly 10 according to the disclosure, wherein the opposing hoisting side is connected to a further valve disc 92 of the corresponding valve block. The additional valve disc is preferably designed according to the data sheet mentioned at the beginning. The lowering side is the side with which the hoisting mechanism can be pressed against the ground on which the mobile machine is traveling. The pressure reducing valve 50 can be used to adjust the compressive force with which the hoisting mechanism presses against the ground. In particular, this compressive force can be adjusted or controlled proportionally.

The first supply point 21 is supplied with pressurized fluid by a pump (not shown). The pressurized fluid is preferably a liquid and most preferably hydraulic oil. The first return flow point 23 is connected to a tank (not shown) from which the pump draws the pressurized fluid. This results in an open hydraulic circuit. The separate second return flow point 24 is also connected to the tank, wherein preferably all control components are connected that should operate as independently as possible of the volume flow that performs hydraulic work.

The supply fluid flow path 13 passes from the first supply point 21 via the pressure reducing valve 50, further via the second control point 12, further via the first 3/2-way switching valve 70, then via the first control point 11, then via the 2/2-way poppet valve 60 to the discharge point 20.

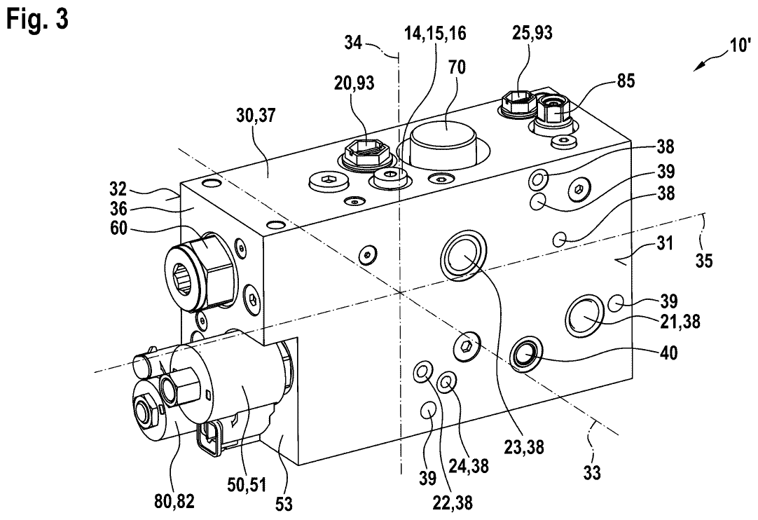

The pressure reducing valve 50 is also connected to the first return flow point 23 on the inlet side. It is designed such that the pressure at the second control point 12 depends on the current in the first actuating solenoid 51, wherein it can lie between the pressure at the first return flow point 23 and the pressure at the first supply point 21. All other components in the inlet flow path 13 are designed to be low-resistance when open, so that the pressure at the second control point 12 is essentially equal to the pressure acting in the cylinders 90. The pressure reducing valve 50 is a commercially available component, preferably designed as a cartridge valve, in particular as a screw-in valve, wherein it is installed in a standardized mounting hole in the main body (No. 30 in FIG. 3).

The 2/2-way poppet valve 60 can be used to shut off the supply fluid flow path 13 in a fluid-tight manner. It is arranged directly adjacent to the discharge point 20 so that it can maintain the load on the cylinders 90. When the 2/2-way poppet valve 60 is closed, the cylinders 90 therefore do not move in the lifting direction of the hoisting mechanism, even if the pressure at the first supply point 21 is not sufficient to maintain the load acting on the cylinders. For safety reasons, the discharge point 20 is connected to the pressure relief valve 85, which limits the pressure at the discharge point 20 to a fixed value. The hoisting mechanism thus yields to the external load before damage to the mobile machine occurs. The pressure relief valve 85 is preferably equipped with an emergency drain function 86 so that it can be opened manually. The pressure relief valve 85 is preferably equipped with a re-suction function which, for example, becomes effective when the hoisting mechanism is lowered quickly in order to prevent negative pressure in the cylinders 90. Pressure fluid then flows from the tank via the first return connection 23 and further via the pressure relief valve 85 to the discharge point 20 until the pressure in the cylinders 90 is essentially equal to the pressure in the tank.

The valve block according to the data sheet explained at the beginning operates according to the load sensing principle, in which a maximum load pressure is determined by means of a shuttle valve cascade, wherein the feed pressure of the pump is regulated by a predetermined pressure difference above this maximum load pressure. When determining the maximum load pressure, consumers that are not moving are not taken into account in order to avoid energy losses due to unnecessarily high feed pressure from the pump. The load pressure of the valve assembly 10 according to the disclosure is the pressure at the discharge point 20. However, the pressure at the first control point 11 is reported to the shuttle valve (No. 40 in FIG. 2) of the shuttle valve cascade mentioned above. When the 2/2-way poppet valve 60 is open, these two pressures are equal. However, when the 2/2-way poppet valve 60 is closed so that the cylinders 90 cannot move, the low pressure in the tank should be applied to the first control point 11 so that it is reported to the shuttle valve cascade.

This is achieved according to the disclosure by the first 3/2-way switching valve 70. This has a first switching position 74 in which the supply fluid flow path 13 is open. In a second switching position 75, the supply fluid flow path 13 is blocked, wherein the first control point 11 is connected to the first return connection 23. So that the 2/2-way poppet valve 60 and the first 3/2-way switching valve 70 do not have to be actuated by two separate solenoids, the 2/2-way poppet valve 60 is equipped with a hydraulic actuation via a first actuating connection 61. The first actuating connection 61 is in turn connected to the second control point 12, wherein this can be done either permanently and with low resistance 16 or via a constant inductor 14 or via an inductor non-return valve 15. FIG. 3 shows in this regard that the corresponding component is designed as a replaceable insert.

If the cylinders 90 with the 2/2-way poppet valve 60 are now to be shut down, the pressure at the second control point 12 is first reduced by the pressure reducing valve 50. Then the second switching position 75 is set on the first 3/2-way switching valve 70 by means of the second actuating solenoid 82. In the first embodiment, the second actuating solenoid 82 must be de-energized for this purpose because the second switching position 75 is pretensioned by the second spring 76, wherein the first switching position 74 is set by energizing the second actuating solenoid 82. In the event of a power failure, the cylinders 90 cannot move. This setting already blocks the supply fluid flow path 13, but it is not yet leak-free. Leak-free operation is achieved by closing the 2/2-way poppet valve 60 by reducing the pressure at the second control point 12 as explained above by adjusting the pressure reducing valve 50 with the first actuating solenoid 51. As a result, the 2/2-way poppet valve 60 moves to its closed position 65, which is pretensioned by the first spring 67. By applying pressure to the first actuating connection 61, the 2/2-way poppet valve 60 is moved to its open position 64. The 2/2-way poppet valve 60 is also a commercially available valve, which is preferably designed as a cartridge valve, wherein it is installed in a standardized mounting hole.

If the hoisting mechanism is to be raised, the pressure required for this is provided by the further valve disc 92. Via the valve assembly 10 according to the disclosure, the pressure fluid flowing back from the cylinders 90 flows to the tank via the first return flow point 23. For this purpose, the 2/2-way poppet valve 60 is moved to the open position 64 by suitable adjustment of the pressure reducing valve 50. In particular, the pressure at the second control point 12 is set correspondingly high. Even in this operating state, the first 3/2-way switching valve 70 is advantageous, since the corresponding volume flow can be directed directly to the first return flow point 23, bypassing the pressure reducing valve 50, which is not possible with EP 3 321 515 A1. This results in lower counterpressure on the return side of the cylinders 90. The low pressure at the first return flow point 23 is reported to the shuttle valve cascade, thus avoiding unnecessary energy losses.

A pressure sensor 91 can optionally be connected to the discharge point 20, which is mounted on a separate sensor connection 25 (see FIG. 3). For the first and second inductors 41; 42, reference is made to the explanations in FIG. 2.

FIG. 2 shows a hydraulic circuit diagram of a second embodiment of a valve assembly 10 according to the disclosure. FIG. 2 shows the channels running parallel to the longitudinal axis (No. 33 in FIG. 3) in the main body, which are also present in the first embodiment. The first and second supply points 21; 22 and the first and second return flow points 23; 24 are each formed by one such channel 38, so that in a valve block with several valve discs, there is one continuous channel in the valve block. In the present embodiment, two further channels 38 are provided, which are irrelevant for the function of the valve assembly 10′ according to the disclosure, wherein they are relevant for other valve discs of the valve block.

The shuttle valve 40 is installed in the main body in such a way that when several valve discs are assembled, a shuttle valve cascade is formed. In the present case (see FIG. 3), the shuttle valve 40 is installed in the first sealing surface 31, whereby the output of the shuttle valve 40 is arranged therein. One inlet of the shuttle valve 40 is aligned in the direction of the longitudinal axis (No. 33 in FIG. 3) and leads out to the outlet on the second sealing surface 32. The other inlet of the shuttle valve 40 is connected to the first control point 11. The corresponding connection is provided with a first and a second inductor 41; 42, each of which has a constant flow resistance. The first inductor 41 is connected between the first control point 11 and the shuttle valve 40, wherein the second inductor 42 is connected between the first control point 11 and the second return flow point 23. The first inductor 41 is intended to transmit rapid pressure fluctuations at the first control point 11 to the shuttle valve 40 in a damped form. These would interfere with the setting of the feed pressure of the pump, since the pump cannot respond as quickly as desired to changes in the pressure setpoint. The second inductor 42 is intended to prevent a pressure from building up at the first control point 11 due to leaks, which does not correspond to the actual load. The second inductor 42 is therefore preferably designed to be very small.

The second embodiment differs from the first embodiment primarily in the actuation of the first 3/2-way switching valve 70. In the second embodiment, this is hydraulically actuated via a second actuating connection 73. As a result, even with large volume flows and/or pressures in the supply fluid flow path 13, a small second actuating solenoid 82 is sufficient. This directly actuates a second 3/2-way switching valve 80. Depending on the current applied to the second actuating solenoid 82, this either switches the pressure in the second return flow point 24 or the pressure at the second supply point 22 to the second actuating connection 73. This actuation is also designed so that the supply fluid flow path 13 is blocked by the first 3/2-way switching valve 70 in the event of a power failure. In particular, the second actuating connection 73 is then connected to the second return flow point 24, so that the second switching position 75 is set.

FIG. 3 shows a perspective view of the valve assembly 10′ according to FIG. 2 from the valve side 36. The valve assembly 10′ comprises a one-piece main body 30, the outer shape of which is essentially cuboid. The first and second sealing surfaces 31; 32 are each flat and perpendicular to a longitudinal axis 33, wherein they face away from each other. The main body 30 bears against further valve discs of the valve block at the first and second sealing surfaces 31; 32.

A vertical axis 34 is aligned perpendicular to the longitudinal axis 33, wherein a connection side 37 is flat and aligned perpendicular to the vertical axis 34. On the connection side 37, the discharge point 20 is led out in the form of a connection with an internal thread, which is detachably closed in the present case with a sealing plug 93.

The first 3/2-way switching valve 70 is installed from the connection side 37, wherein it is aligned parallel to the vertical axis 34. If the first embodiment were to be realized based on the second embodiment shown, the second 3/2-way switching valve 80 would be omitted, wherein the second actuating solenoid 82 would be arranged directly on the 3/2-way switching valve 70, wherein it would protrude from the main body 30 on the connection side 37. No further changes would be necessary. Accordingly, all other explanations relating to FIGS. 2 and 3 also apply to the first embodiment. The first 3/2-way switching valve 70 is arranged so that it crosses the channel 38, which forms the first return flow point 23, directly, so that this connection is particularly low-resistance. It should be noted here that the position of the six channels 38 parallel to the longitudinal axis 33 is fixed by the modular system of the valve block in accordance with the data sheet mentioned at the beginning.

The pressure relief valve 85 is also installed on the connection side 37 and is likewise aligned parallel to the vertical axis 34. The sensor connection 25 is located directly adjacent to this and is currently closed with a removable sealing plug 93.

Note the screw insert marked with reference numbers 14, 15, and 16. This can be designed so that either a permanent, low-resistance connection 16, a constant inductor 14, or an inductor non-return valve 15 is implemented there. For the corresponding circuitry, reference is made to the design in FIG. 1.

The transverse axis 35 is aligned perpendicular to the longitudinal axis 33 and to the vertical axis 34. The valve side 36 is largely flat and perpendicular to the transverse axis 35, wherein it is provided with a recess 53 in the region of the pressure reducing valve 50. The recess 53 is intended to ensure that the first actuating solenoid 51 of the pressure reducing valve 50 protrudes as little as possible beyond the main body 30. In particular, it should not protrude from the defined installation space of the valve block in accordance with the data sheet mentioned at the beginning, so that the valve unit according to the disclosure can also be used in existing mobile machines.

The pressure reducing valve 50 is installed from the valve side 36, wherein it is aligned parallel to the transverse axis 35. Its front side outlet connection (No. 52 in FIG. 2) is arranged directly adjacent to a first radial connection (No. 71 in FIG. 2) so that this section of the supply fluid flow path (No. 13 in FIG. 2) is particularly short and low-resistance.

The 2/2-way poppet valve 60 is also installed from the valve side 36, wherein it is aligned parallel to the transverse axis 35. Its front side main connection (No. 62 in FIG. 2) is located directly adjacent to the outlet connection 20, so that this section of the supply fluid flow path (No. 13 in FIG. 2) can be designed to be particularly short and low-resistance. The 2/2-way poppet valve 60 is the valve on the valve side 36 which is located closest to the connection side 37. This also contributes to minimizing the flow resistance of the said section of the supply fluid flow path.

The remaining installation space on the valve side 36 is used for the second 3/2-way switching valve 80, which is aligned parallel to the transverse axis 35. The corresponding connections to the other components of the valve assembly 10′ are not part of the supply fluid flow path, so that long and thin connecting bores can also be used.

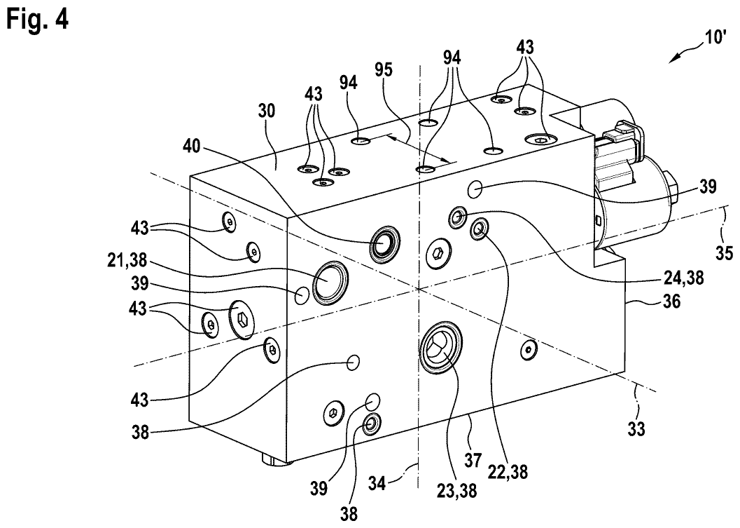

FIG. 4 shows another perspective view of the valve assembly 10′ according to FIG. 3 from the opposite side. It should be noted that no components protruding from the main body 30 are installed on the side of the main body 30 facing away from the valve side 36. Only screw plugs 43 are provided to close the orifices of the drilled connecting channels in the main body 30 in a fluid-tight manner.

Similarly, no components protruding from the main body 30 are installed on the side facing away from the connection side 37. Only screw plugs 43 for drilled connection channels are screwed in there. This side can then serve as an attachment point for securing the corresponding valve block to the mobile machine. Threaded holes 94 are provided for this purpose. Preferably, only two of the four threaded holes 94 are used, namely those that are aligned in the direction of the transverse axis 35. The distance 95 measured in the direction of the longitudinal axis 33 corresponds to the standardized thickness of a valve disc of the valve block according to the data sheet mentioned at the beginning. This makes it possible to install an additional valve disc in the valve block, wherein the valve assembly 10′ according to the disclosure can still be used as a fastening point.

### REFERENCE NUMERALS

10 valve assembly (first embodiment)
10′ valve assembly (second embodiment)
11 first control point
12 second control point
13 supply fluid flow path
14 inductor
15 inductor non-return valve
16 permanent, low-resistance connection
20 discharge point
21 first supply point
22 second supply point
23 first return flow point
24 second return flow point
25 sensor connection
30 main body
31 first sealing surface
32 second sealing surface
33 longitudinal axis
34 vertical axis
35 transverse axis
36 valve side
37 connection side
38 channel parallel to the longitudinal axis
39 tension rod hole
40 shuttle valve
41 first inductor
42 second inductor
43 screw plug
50 pressure reducing valve
51 first actuating solenoid
52 front side outlet connection
53 recess on the main body
60 2/2-way poppet valve
61 first actuating connection
62 front side main connection
63 radial main connection
64 open position
65 closed position
66 valve seat
67 first spring
70 first 3/2-way switching valve
71 first radial connection
72 second radial connection
73 second actuating connection
74 first switching position
75 second switching position
76 second spring
80 second 3/2-way switching valve
82 second actuating solenoid
85 pressure relief valve
86 emergency drain function
90 cylinder
91 pressure sensor
92 further valve disc
93 sealing plug
94 threaded hole
95 distance of the threaded holes in the direction of the longitudinal axis

What is claimed is:

1. A valve assembly, comprising:
a first supply point;
a first return flow point;
a discharge point;
a pressure reducing valve;
a 2/2-way poppet valve;
a first actuating solenoid configured to adjust the pressure reducing valve;
a second actuating solenoid configured to at least indirectly adjust the 2/2-way poppet valve; and
a first 3/2-way switching valve arranged in a supply fluid flow path between the pressure reducing valve and a first control point,
wherein the supply fluid flow path passes from the first supply point via the pressure reducing valve, further via the first control point, further via the 2/2-way poppet valve to the discharge point,
wherein the first control point is connected on an inlet side to a shuttle valve,
wherein the shuttle valve is installed in a shuttle valve cascade,
wherein the first control point is selectively connected to the pressure reducing valve or to the first return flow point by the first 3/2-way switching valve,
wherein the second actuating solenoid is configured to adjust the first 3/2-way switching valve,
wherein a second control point is arranged between the pressure reducing valve and the first 3/2-way switching valve in the supply fluid flow path,
wherein the 2/2-way poppet valve is hydraulically actuated via a first actuating connection,
wherein the first actuating connection is connected to the second control point, such that the 2/2-way poppet valve is indirectly adjustable using the first actuating solenoid and/or the second actuating solenoid.

2. The valve assembly according to claim 1, wherein only an inductor or only an inductor non-return valve is connected between the second control point and the first actuating connection.

3. The valve assembly according to claim 1, wherein:
the first 3/2-way switching valve is moved into a first switching position by energizing the second actuating solenoid, in which the supply fluid flow path is open, and
the first 3/2-way switching valve is pretensioned by a second spring into a second switching position in which the first control point is connected to the first return flow point.

4. The valve assembly according to claim 3, further comprising:
a second 3/2-way switching valve directly adjusted by the second actuating solenoid,
wherein the first 3/2-way switching valve is hydraulically actuated via a second actuating connection, and
the second actuating connection is connected on an output side to the second 3/2-way switching valve.

5. The valve assembly according to claim 4, further comprising:
a main body including a first sealing surface and a second sealing surface each formed flat and perpendicular to a longitudinal axis while facing away from each other,
wherein the first supply point and the first return flow point are each formed as a channel parallel to the longitudinal axis directly in the main body,
wherein the channel opens out at the first sealing surface and second sealing surface,
wherein a vertical axis is aligned perpendicular to the longitudinal axis,
wherein the discharge point opens out in a direction of the vertical axis directly at a connection side on the main body, and
wherein a transverse axis is arranged perpendicular to the longitudinal axis and to the vertical axis.

6. The valve assembly according to claim 5, wherein:
the 2/2-way poppet valve and the pressure reducing valve are each configured as a cartridge valve aligned parallel to the transverse axis, and
the 2/2-way poppet valve and the pressure reducing valve are installed in the main body from a common valve side.

7. The valve assembly according to claim 6, wherein:
a front side main connection of the 2/2-way poppet valve is permanently connected to the discharge point, to form a portion of the supply fluid flow path, and
the 2/2-way poppet valve is arranged adjacent to the connection side on the main body.

8. The valve assembly according to claim 6, wherein:
the first 3/2-way switching valve is configured as a cartridge valve installed parallel to the vertical axis in the main body, and
the pressure reducing valve has a front side outlet connection permanently connected to a first radial connection of the first 3/2-way switching valve to form a portion of the supply fluid flow path.

9. The valve assembly according to claim 8, wherein a radial main connection of the 2/2-way poppet valve is permanently connected to a second radial connection of the first 3/2-way switching valve to form a section of the supply fluid flow path.

10. The valve assembly according to claim 8, wherein the second actuating connection is arranged on a front side of the first 3/2-way switching valve.

11. The valve assembly according to claim 5, further comprising:
a pressure relief valve configured to connect the discharge point to the first return flow point.

12. The valve assembly according to claim 11, wherein:
the pressure relief valve is configured as a cartridge valve aligned parallel to the vertical axis, and
the pressure relief valve is installed in the main body from the connection side.

13. The valve assembly according to claim 5, wherein:
at least one fastening thread is arranged in the main body on a side facing away from the connection side in the direction of the vertical axis, and
the at least one fastening thread passes parallel to the vertical axis.

14. The valve assembly according to claim 1, further comprising:
a control fluid flow path passing from the shuttle valve via a first inductor, further via the first control point, further via a second inductor either to a second return flow point or to the first return flow point.
